(19) United States
(12) Patent Application Publication
(10) Pub. No.: US 2014/0113108 A1
(43) Pub. Date: Apr. 24, 2014

(54) Comfort Bed Exam

(71) Applicant: William J. Harris, Tampa, FL (US)

(72) Inventor: William J. Harris, Tampa, FL (US)

(21) Appl. No.: 13/656,996

(22) Filed: Oct. 22, 2012

(51) Int. Cl. B32B 33/00; B32B 5/18; B32B 3/06

(52) U.S. Cl. 428/141; 428/409; 428/343; 428/304.4

(57) ABSTRACT

Disclosed is a gripping sheet for placement on a veterinarian pet examination table. The sheet comprises a gripping top surface for preventing a pet from slipping and sliding when being treated thereon.

### PRIORITY

The present invention claims priority under 35 USC section 119 and based upon a provisional application which was filed on Oct. 21, 2011 with a Ser. No. 61/549,876.

### BACKGROUND

The present invention relates to veterinary utilities and more particularly to a gripping sheet for preventing a pet from slipping and sliding on a veterinarian pet examination table while being treated thereon.

The tabletops of pet examination tables, whereon pets are treated by veterinarians, are generally smooth as they are made of materials, such as, stainless steel, Formica, and etc. Added to the fact that pets, on most occasions, are not cooperative when being treated, these smooth, and thereby slippery, tabletops only make pet treatment sessions even more unmanageable, thus requiring veterinarians to be on their toes during the treatment. Sometimes, an extra hand is needed to hold down a pet on the examination table so as to help a veterinarian focus better on the animal being treated. Further, these tabletops are also hard and have high temperature conductivity, which makes it inconvenient to the pets themselves. Hygiene is yet another issue veterinarians need to keep up with as it is not always convenient to move and clean the cumbersome examination tables every now and then. Therefore, in the light of what is discussed, there is a need in the art for a veterinary utility that not only make the tabletops less slippery for pets but also relatively warm, cushiony and clean.

### SUMMARY

A gripping piece for placement on a veterinarian pet examination table, the piece may include a gripping top surface for preventing a pet from slipping and sliding when being treated thereon.

The gripping piece may include a sheet.

The gripping piece may include an adhesive bottom surface about which, the gripping piece is attached to the tabletop of the examination table.

The adhesive surface may be non-sticky so that, no residue is left when removed from the examination table.

The gripping piece may be made of foam material.

The gripping piece may be of polyethylene.

The polyethylene may be of low density.

The gripping piece may be moisture-repellant.

The gripping surface may be textured.

The gripping piece may be a mat.

Other objects and advantages of the embodiments herein will become readily apparent from the following detailed description taken in conjunction with the accompanying drawings.

### BRIEF DESCRIPTIONS OF THE DRAWINGS

FIG. 1 is a view of the gripping sheet according to an embodiment of the present invention.

FIG. 2 is a view of the gripping sheet placed on a pet examination table according to an embodiment of the present invention.

FIG. 3 is, according to an embodiment of the present invention, a view of the gripping sheet placed on the pet examination table with a portion of the adhesive surface thereof not exposed.

### FIGURES—REFERENCE NUMERALS

10 . . . Gripping Sheet
12 . . . Pet Examination Table
14 . . . Gripping Surface
16 . . . Adhesive Surface

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

A gripping piece for placement on a veterinarian pet examination table, the gripping piece comprising a gripping top surface for preventing a pet from slipping and sliding when being treated thereon and an adhesive bottom surface about which, the gripping piece is attached to the tabletop of the examination table. The present invention is a gripping sheet for placement on the tabletop of a pet examination table. The sheet comprises a gripping, moisture-repellant, top surface whereon a pet is treated and an adhesive bottom surface about which, the sheet is attached to the examination table. The sheet is made of a foamy material, which makes it warm and cushiony.

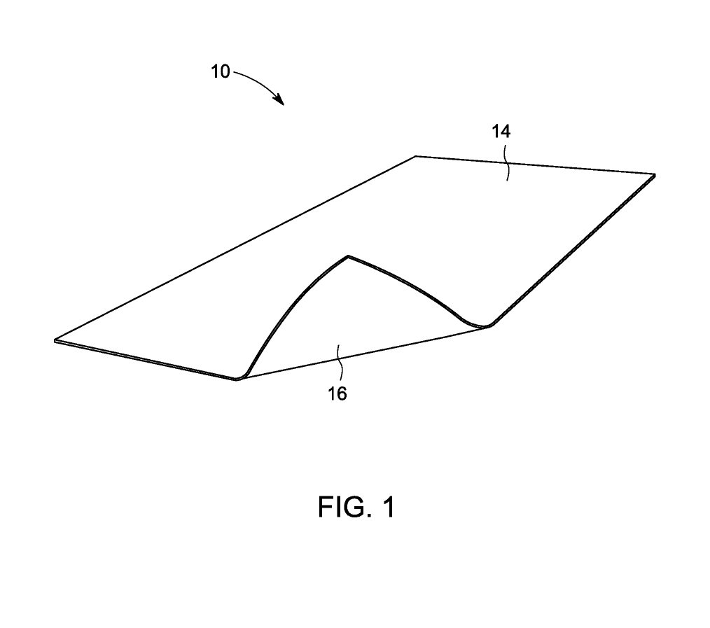

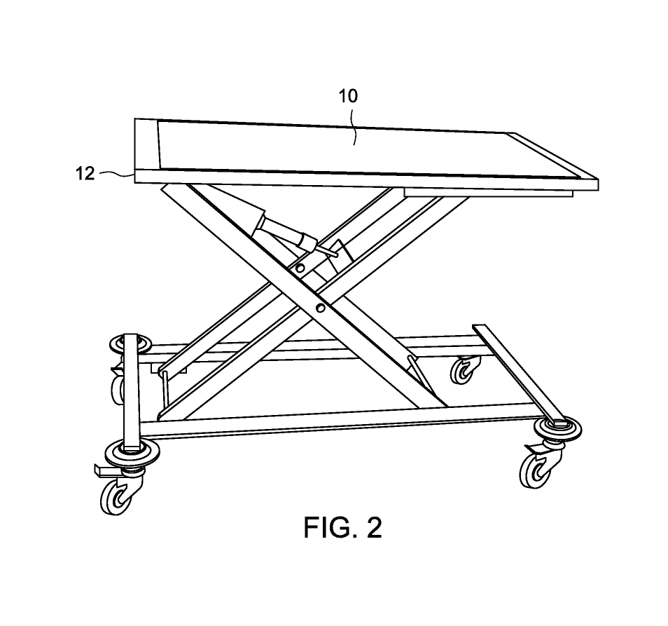

The preferred embodiment of the present invention comprises a gripping piece for placement on a smooth tabletop or work surface of a veterinary pet examination table. Referring to FIGS. 1 and 2, the gripping piece, more particularly, comprises a sheet—a gripping sheet 10—for preventing a pet from sliding and slipping on the examination table 12 while being treated. The gripping sheet 10 may be made of a moisture-repellant or waterproof (which prevents moisture from penetrating the surface) low density polyethylene or other appropriate material. Being moisture-repellant or waterproof allows the gripping sheet 10 to be cleaned by substantially any disinfectant cleaner known in the art. In another embodiment, the gripping sheet 10 is made of a foam material. In either embodiment, the material of the gripping sheet 10 is soft (sponge like) and has low temperature conductivity and therefore, keeps the pet warm and comfortable on the examination table 12 during the treatment.

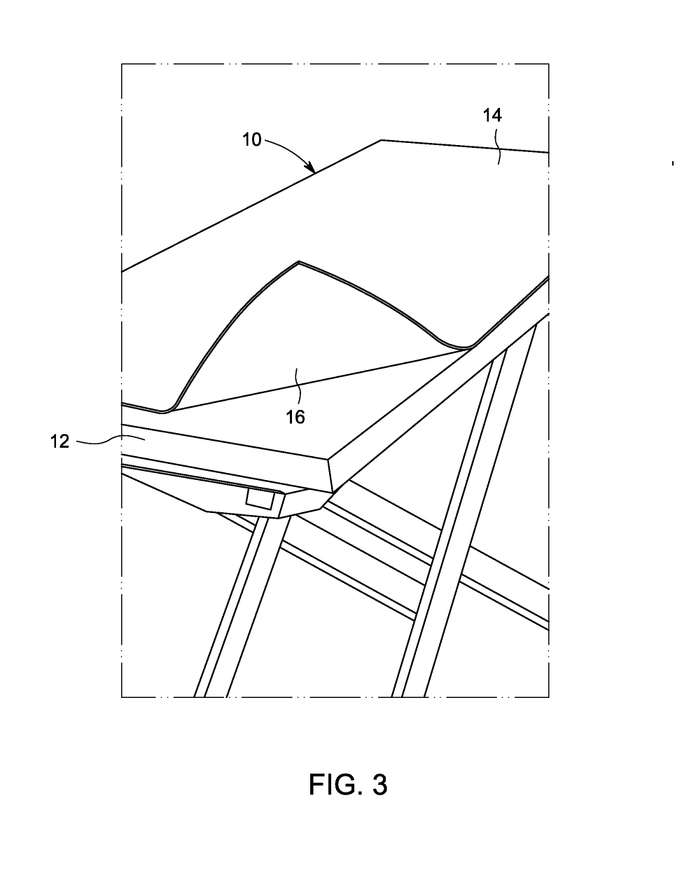

Referring to FIGS. 1, 2 and 3, the gripping sheet 10 comprises a gripping top surface 14, whereon a pet is placed for treatment, and an adhesive bottom surface 16 which may allow the bottom surface 16 to be nondestructively detachably connected to the examination table 12, and consequently about which, the gripping sheet 10 is attached to the examination table 12. In one embodiment, the gripping surface 14 comprises textured surface for providing an extra grip to the animal being examined. The adhesive used for the adhesive surface 16 is essentially non-sticky so that, no residue is left when removed from the examination table 12. Other devices may, however, be employed for enabling the gripping sheet 10 to ‘stay’ on the examination table 12. For example, in one embodiment, the gripping sheet may comprise a plurality of elongate strips or other shaped devices extending from one side and a plurality of loops or hooks disposed on the other. The strips are secured to the opposingly-disposed loops or hooks (Velcro) in order to nondestructively and detachably secure the gripping sheet to the examination table. In another embodiment, the gripping piece may comprise a relatively heavy mat instead of a sheet. The bottom surface thereof may be lined with a rubbery material having a relatively high coefficient of friction so that, the weight of the mat combined with the rubbery material prevents the mat itself from sliding on the examination table. The dimensions of the gripping sheet may be sized as they fit most of the examination tables. The gripping sheet can, however, be made to other dimensions as well.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

1. A gripping piece for placement on a veterinarian pet examination table, the piece comprising a gripping top surface for preventing a pet from slipping and sliding when being treated thereon and a bottom surface of the gripping piece being attached to a top surface of the tabletop of the examination pet table.

2. The gripping piece of claim 1 comprising a sheet.

3. The gripping piece of claim 1 further comprising an adhesive bottom surface, about which the gripping piece is attached to a tabletop of the examination table.

4. The gripping piece of claim 3 wherein, the adhesive surface is non-stick, so that no residue is left when removed from the examination table.

5. The gripping piece of claim 1 made of foam material.

6. The gripping piece of claim 1 made of polyethylene.

7. The gripping piece of claim 6, wherein the polyethylene is of a low density.

8. The gripping piece of claim 1 being moisture-repellant.

9. The gripping piece of claim 1, wherein the gripping surface is textured.

10. The gripping piece of claim 1 comprising a mat.

11. A gripping piece for placement on a veterinarian pet examination table, the gripping piece comprising a gripping top surface for preventing a pet from slipping and sliding when being treated thereon and an adhesive bottom surface, about which the gripping piece is attached to the tabletop of the examination table.
